(19) United States
(12) Patent Application Publication
(10) Pub. No.: US 2013/0036623 A1
(43) Pub. Date: Feb. 14, 2013

(54) Apparatus and Method for a Dryer Iron Clip

(71) Applicant: Lisa Kraetsch, Pagosa Springs, CO (US)

(72) Inventor: Lisa Kraetsch, Pagosa Springs, CO (US)

(21) Appl. No.: 13/207,004

(22) Filed: Aug. 10, 2011

(51) Int. Cl. D06F 59/02; F26B 3/02; B23P 19/04; D06C 5/00

(52) U.S. Cl. 34/381; 223/61; 29/428

(57) ABSTRACT

A wrinkle-reducing clip is described for use in drying articles of fabric, such as clothing. The clip is applied to clothing during a drying process. The clip comprises a clip body and sliding tension clasp which holds the material within the clip during drying. The clip may be utilized with fabrics containing varying moisture-levels and with a variety of drying methods, such as a clothes line (e.g., air drying) to a conventional dryer. Also, the clip may be made from a variety of heat-resistant materials, such as plastic, and may comprise a number of shapes to accommodate any number of clothing styles, sizes, or wrinkle areas.

### FIELD OF THE INVENTION

The present invention relates generally to clips and, more specifically, to a clip applied to wet clothing in order to hold the fabric in place while drying, thereby reducing garment wrinkles

### SUMMARY OF THE INVENTION

Exemplary embodiments and related methodologies of the present invention provide a clip for use in drying articles of fabric, such as clothing. The clip is applied to clothing during the drying process to reduce wrinkles The clip is attached to the clothing via the use of a sliding tension clasp that presses the two sides of the clip body together, thus holding the fabric between the opposing surfaces of the clip body. Thereafter, while the clip is still in place, the clothing is dried using any suitable method, thereby reducing wrinkles The clip may be made from a variety of heat-resistant materials, such as plastic, and may comprise a number of shapes to accommodate any number of clothing styles, sizes, or wrinkle areas. In addition, the clip may be utilized with fabrics containing varying moisture-levels and with a variety of drying methods, such as a clothes line (e.g., air drying) to a conventional dryer.

### BRIEF DESCRIPTION OF THE DRAWINGS

FIG. 1A is a front view of a clip in the open position according to an exemplary embodiment of the present invention;

FIG. 1B shows the clip of FIG. 1 in the closed position;

FIG. 2A shows a back view of the clip of FIG. 1A in the open position;

FIG. 2B shows a back view of the clip of FIG. 1B in the closed position;

FIG. 3A shows a sectional view of the clip in the open position along line 3A of FIG. 1;

FIG. 3B shows a sectional view of the clip in the closed position along line 3B of FIG. 1;

FIG. 4 shows a clip applied to a shirt collar in accordance to an exemplary methodology of the present invention;

FIG. 5 shows a clip applied to a shirt placket in accordance to an exemplary methodology of the present invention; and

FIG. 6 shows a clip applied to a hem in accordance to an exemplary methodology of the present invention.

### DESCRIPTION OF ILLUSTRATIVE EMBODIMENTS

Illustrative embodiments and related methodologies of the present invention are described below as they might be employed in the manufacture and use of a dryer iron clip. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the drawings and the following description.

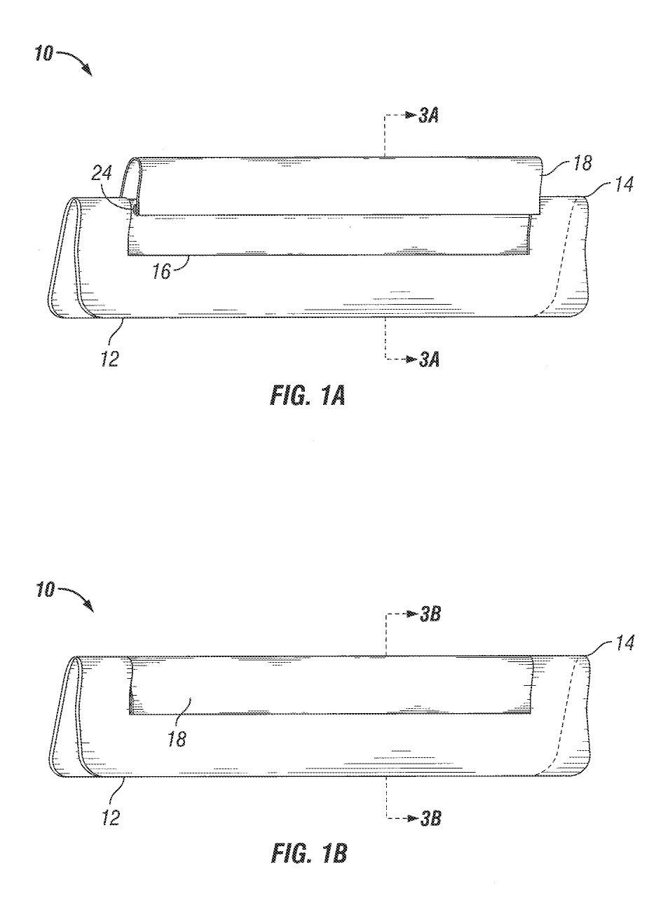

FIGS. 1A and 1B illustrate a clip 10 according to an exemplary embodiment of the present invention. Clip 10 is comprised of a clip body 12 made of a light-weight, durable, heat-resistant plastic or other suitable material. Clip body 12 is comprised of two opposing surfaces, which are flat in this embodiment, connected to one another by hinge mechanism (not shown). The hinge mechanism may be an actual hinge or simply a thinning area located at the apex 14 of the V-shaped clip body 12. If a thinning area is utilized, the two sides of clip body 12 are simply folded together to form the V-shape. One ordinarily skilled in the art having the benefit of this disclosure realizes that a variety of hinge mechanism may be utilized in accordance with the present invention. Clip body 12 may be formed using any suitable process known in the art, such as molding.

A sliding tension clasp 18 fits atop apex 14 of clip body 12. Sliding tension clasp 18 slips over the two sides of clip body 12 in order to hold the clip firmly together. In this exemplary embodiment, sliding tension clasp 12 is made of plastic material. However, other suitable materials, such as metal, may also be utilized as would be understood by one ordinarily skilled in the art having the benefit of this disclosure. On the front side of clip 10 (FIGS. 1A & 1B), is a grooved indented section 16 which assists in guiding and holding sliding tension clasp 18 over slip body 12. Indented section 16 is formed to mate with the size and shape of tension clasp 18.

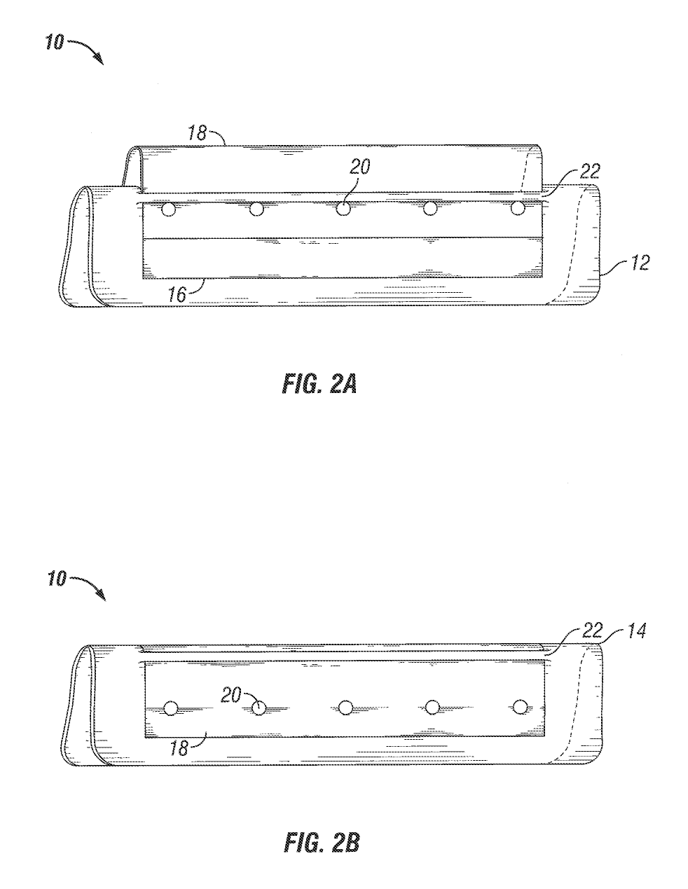

Referring to FIGS. 2A and 2B, the back of clip 10 is illustrated. A plurality of buttons 20 are spaced along the rear facing side of sliding clasp 18. Also, a catch bar 22 is attached to the rear side of clip body 12. In this exemplary embodiment, catch bar 22 is integrally formed as part of clip body 12. However, catch bar 22 may be applied using other means known in the art. As sliding tension clasp 18 is pushed down over clip body 12 (FIG. 2B), the rear side of clasp 18 will slide between catch bar 22 of the outer surface of clip body 12. As such, buttons 20 will also slide underneath catch bar 22. The buttons are raised knobs extending from the surface of clasp 18 enough that, once clasp 18 has been fully slipped atop clip body 12, buttons 20 will “catch” catch bar 22, thus preventing clasp 18 from being inadvertently removed from clip body 12.

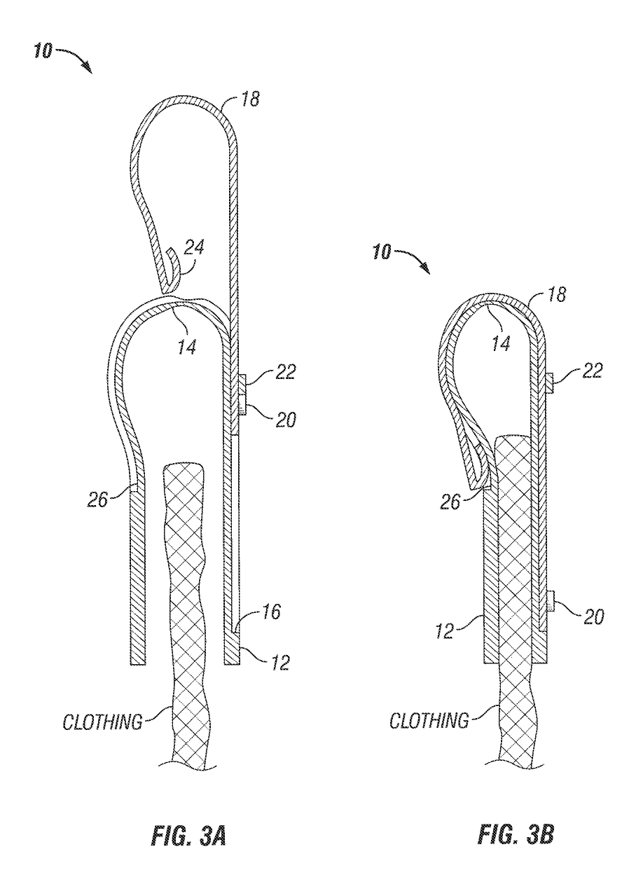

Referring to FIGS. 3A and 3B, a sectional view of clip 10 is illustrated in the open and closed position, respectively. In FIG. 3A, sliding tension clasp 18 has yet to be pushed atop clip body 12 (in the open position). As shown in this exemplary embodiment, apex 14 is hinged by providing a thinning area at apex 14, thereby providing a means whereby the two sides can be easily folded on one another. A rolled portion 24 is located on the bottom edge of the front side surface of tension clasp 18 to aid in the sliding engagement of clasp 18. Also, a indent 26 is located on the front side surface of clip body 12 and extends along the entire length of the front side surface. When tension clasp 18 has been fully placed atop clip body 12 (in closed position shown in FIG. 3B), rolled portion 24 mates with the indent 26 to assist in preventing movement of clasp 18.

In this exemplary embodiment, the size of clip 10 may range from 4-7 inches in length and 1.5-2 inches in width. However, those ordinarily skilled in the art having the benefit of this disclosure realize the dimensions may vary dependent upon the size of the clothing on which the clip is to be applied, which can include infant to large, heavy-duty clothing.

Exemplary methods of using clip 10 will now be described in reference to FIGS. 3A-6. As described herein, dryer clip 10 is attached to wet materials, such as clothing fabric, in order to reduce wrinkles This exemplary methodology will describe the use of clip 10 in conjunction with clothing. After wet clothing has been removed from the washing machine, or other means of wetting the clothing, clip 10 is applied to any desired area of the clothing in which the potential of curling or wrinkling is present. As shown in FIGS. 3A and 3B, the clothing is placed between the front and rear sides of clip body 12. Sliding tension clasp 18 is then slid into place over clip body 12 to firmly secure clip 10 onto the fabric. Clip 10 then holds the fabric in place while it dries, either naturally (on a clothes-line, for example) or with the assistance of a machine such as, but not limited to, a conventional dryer. When the clothing is dry, clip 10 is removed by sliding tension clasp 18 back to the open position (FIG. 3A) and the fabric is released. As such, the fabric has been kept from wrinkling or curling due to the application of clip 10. Also note that even though clip 10 is now in the open position, buttons 20, acting in conjunction with catch bar 22, prevent clasp 18 from completely separating from clip body 12.

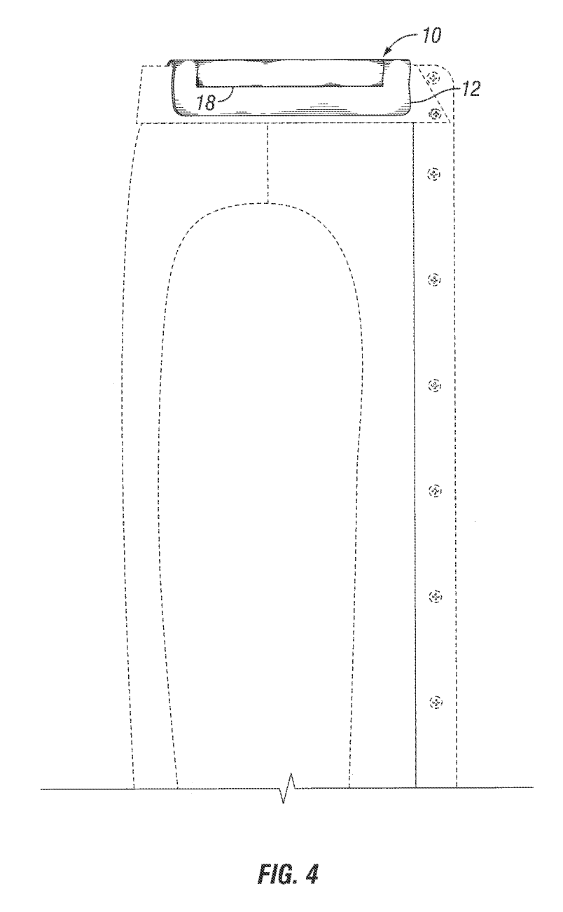

In the exemplary embodiment of FIG. 4, clip 10 is applied to a collar. Clip 10 is shown in the closed position. Clip 10 may be applied to one side or both sides of the collar simultaneously. As previously described, the collar is placed between the open jaws of the front and rear sides of clip body while tension clasp 18 is in the open position (FIG. 3A). Once the fabric is in the proper alignment, tension clasp 18 is slipped into its resting position to hold clip body 12 and the fabric in place (FIG. 3B). The fabric is then dried by any suitable method known in the art. When fabric is dry, tension clasp 18 is slid to the open position and clip 10 is removed. Accordingly, the fabric has been kept from the typical rolling, curling, or wrinkling In this exemplary embodiment, the dimensions of clip 10 may be 4-6 inches in length and 2 inches in width; however, those ordinarily skilled in the art realize other dimensions may be utilized as necessary.

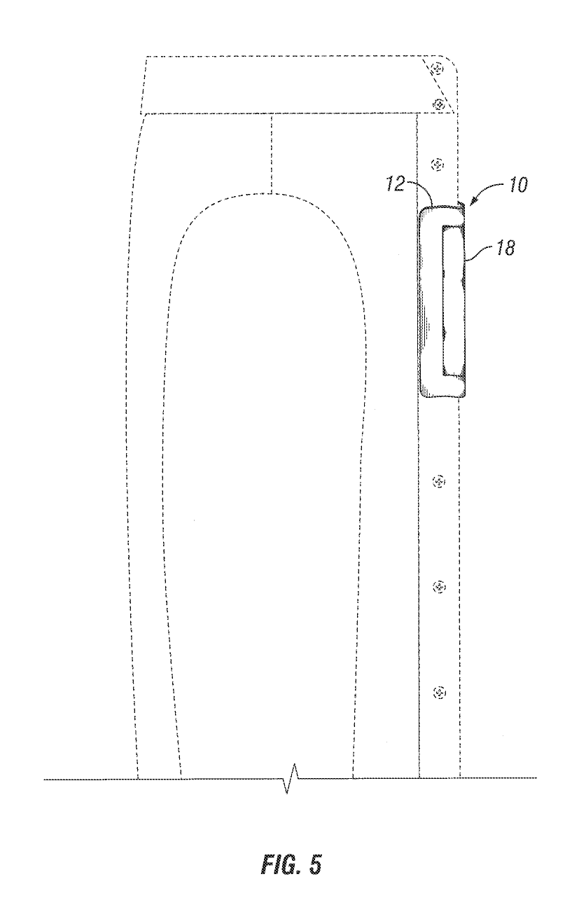

In the exemplary embodiment of FIG. 5, clip 10 is shown in its closed position being applied to a shirt placket. Clip 10 may be applied to one side of the shirt or can hold both sides of the shirt plackets at once. The fabric is placed between the open jaws of the front and rear sides of clip body 12 while tension clasp 18 is in the open position (FIG. 3A). Once the fabric is in the proper alignment, tension clasp 18 is slipped into its resting position to hold the clip body 12 and fabric in place (FIG. 3B). The fabric is then dried by any suitable known means. When the fabric is dry, tension clasp 18 is slid to the open position and clip 10 is removed. Accordingly, the fabric has been kept from the typical rolling, curling, or wrinkling In this exemplary embodiment, the dimensions of clip 10 may be 6-8 inches in length and 1 inch in width; however, those ordinarily skilled in the art realize other dimensions may be utilized as necessary.

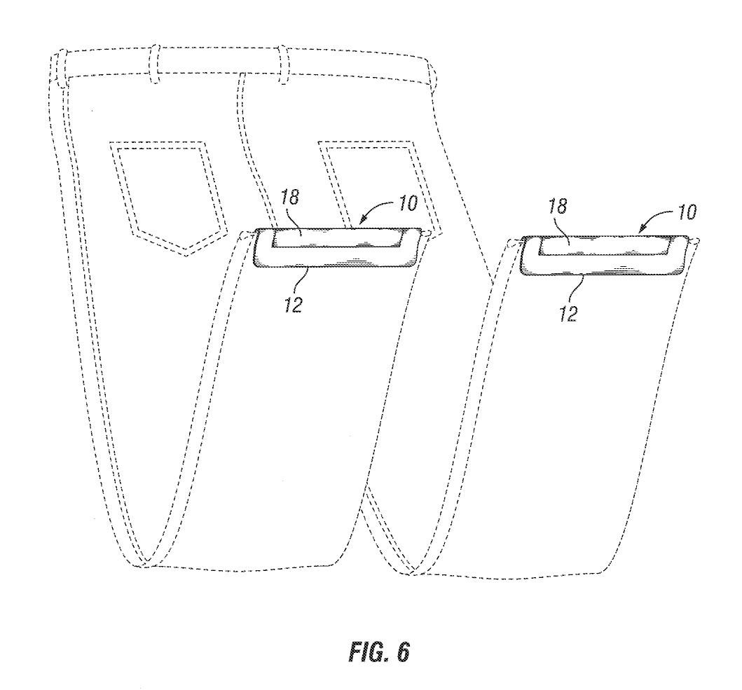

In the exemplary embodiment of FIG. 6, clip 10 is shown in its closed position being applied to a pant hem. Clip 10 may hold both hems, or a single hem (as shown), of the pants. The fabric is placed between the open jaws of the front and rear sides of clip body 12 while tension clasp 18 is in the open position (FIG. 3A). Once the fabric is in the proper alignment, tension clasp 18 is slipped into its resting position to hold the clip body 12 and the fabric in place (FIG. 3B). The fabric is then dried by a suitable known means. When fabric is dry, tension clasp 18 is slid to the open position and clip 10 is removed. Accordingly, the fabric has been kept from the typical rolling, curling, or wrinkling In this exemplary embodiment, the dimensions of clip 10 may be 8 inches in length and 1 inch in width; however, those ordinarily skilled in the art realize other dimensions may be utilized as necessary.

An exemplary embodiment of the present invention provides a clip that is applied to a material during a drying process, the clip comprising a clip body having a first and second opposing surface, the first and second surfaces being joined to one another by a hinge mechanism located at an upper end of the first and second surfaces; and a sliding tension clasp positioned atop the clip body, the sliding tension clasp comprising: a first surface which mates with the first surface of the clip body; and a second surface which mates with the second surface of the clip body, the second surface of the sliding tension clasp opposing the first surface of the sliding tension clasp, wherein the sliding tension clasp is adapted to move up and down the first and second opposing surfaces of the clip body; wherein the clip is in an open position when the sliding tension clasp is moved up the clip body, and the clip is in a closed position when the sliding tension clasp is moved down the clip body, the material being held between the first and second opposing surfaces when the clip is in the closed position during the drying process. In another embodiment, the first surface of the clip body comprises an indented portion which mates with the first surface of the sliding tension clasp. In yet another embodiment, the second surface of the clip body comprises a catch bar extending along a length of the second surface of the clip body.

In another exemplary embodiment, the second surface of the sliding tension clasp comprises at least one button to work in conjunction with the catch bar, whereby the at least one button prevents the sliding tension clasp from detaching from the clip body. In another embodiment, the material is clothing. In yet another, the drying process comprises air drying or machine drying. In another exemplary embodiment, the first surface of the clip body comprises an indent along a length of the first surface of the clip body, and the first surface of the sliding tension clasp comprises a rolled portion at a lower end of the first surface of the sliding tension clasp, the rolled portion mating with the indent along the length of the first surface of the clip body when the clip is in the closed position.

An exemplary methodology of the present invention provides a method utilizing a clip in a drying process, the method comprising the steps of (a) wetting a material; (b) attaching a clip to a portion of the material, the clip comprising first and second opposing surfaces, the attaching comprising the steps of: opening the clip; inserting the material between the first and second surfaces of the clip; and closing the first and second surfaces of the clip, thereby resulting in the inserted material being substantially flattened; and (c) drying the material while the clip is attached to the portion of the material. In another methodology, the material is clothing. In yet another, step (c) comprises drying the material in a drying machine or air drying the material.

Another exemplary methodology of the present invention provides a method utilizing a clip in a drying process, the method comprising the steps of: (a) wetting an article of clothing; (b) attaching the clip to a portion of the clothing, the clip comprising: a clip body having a first and second opposing surface, the first and second surfaces being joined to one another by a hinge mechanism located at an upper end of the first and second surfaces; and a sliding tension clasp positioned atop the clip body, the sliding tension clasp comprising: a first surface which mates with the first surface of the clip body; and a second surface which mates with the second surface of the clip body, the second surface of the sliding tension clasp opposing the first surface of the sliding tension clasp, wherein the sliding tension clasp is adapted to move up and down the first and second opposing surfaces of the clip body; wherein the clip is in an open position when the sliding tension clasp is moved up the clip body, and the clip is in a closed position when the sliding tension clasp is moved down the clip body, the material being held between the first and second opposing surfaces when the clip is in the closed position during the drying process; (c) positioning the clip in the closed position; and (d) drying the clothing while the clip is attached to the clothing. In another methodology, step (d) comprises drying the clothing using the atmosphere or a dryer.

Yet another exemplary methodology of the present invention provides a method of making a clip that is applied to a material during a drying process, the method comprising the steps of: (a) providing a clip body having a first and second opposing surface, the first and second surfaces being joined to one another by a hinge mechanism located at an upper end of the first and second surfaces; and (b) providing a sliding tension clasp positioned atop the clip body, the sliding tension clasp comprising: a first surface which mates with the first surface of the clip body; and a second surface which mates with the second surface of the clip body, the second surface of the sliding tension clasp opposing the first surface of the sliding tension clasp, wherein the sliding tension clasp is adapted to move up and down the first and second opposing surfaces of the clip body; wherein the clip is in an open position when the sliding tension clasp is moved up the clip body, and the clip is in a closed position when the sliding tension clasp is moved down the clip body, the material being held between the first and second opposing surfaces when the clip is in the closed position during the drying process. In another methodology, the first surface of the clip body comprises an indented portion which mates with the first surface of the sliding tension clasp.

In yet another exemplary methodology, the second surface of the clip body comprises a catch bar extending along a length of the second surface of the clip body. In yet another, the second surface of the sliding tension clasp comprises at least one button to work in conjunction with the catch bar, whereby the at least one button prevents the sliding tension clasp from detaching from the clip body. In another, the first surface of the clip body comprises an indent along a length of the first surface of the clip body, and the first surface of the sliding tension clasp comprises a rolled portion at a lower end of the first surface of the sliding tension clasp, the rolled portion mating with the indent along the length of the first surface of the clip body when the clip is in the closed position.

Although various embodiments and methodologies have been shown and described, the invention is not limited to such embodiments and methodologies and will be understood to include all modifications and variations as would be apparent to one skilled in the art. Therefore, it should be understood that the invention is not intended to be limited to the particular forms disclosed. Rather, the intention is to cover all modifications, equivalents and alternatives falling within the spirit and scope of the invention as defined by the appended claims.

What I claim is:

1. A clip that is applied to a material during a drying process, the clip comprising:
a clip body having a first and second opposing surface, the first and second surfaces being joined to one another by a hinge mechanism located at an upper end of the first and second surfaces; and
a sliding tension clasp positioned atop the clip body, the sliding tension clasp comprising:
a first surface which mates with the first surface of the clip body; and
a second surface which mates with the second surface of the clip body, the second surface of the sliding tension clasp opposing the first surface of the sliding tension clasp, wherein the sliding tension clasp is adapted to move up and down the first and second opposing surfaces of the clip body;
wherein the clip is in an open position when the sliding tension clasp is moved up the clip body, and the clip is in a closed position when the sliding tension clasp is moved down the clip body, the material being held between the first and second opposing surfaces when the clip is in the closed position during the drying process.

2. A clip as defined in claim 1, wherein the first surface of the clip body comprises an indented portion which mates with the first surface of the sliding tension clasp.

3. A clip as defined in claim 1, wherein the second surface of the clip body comprises a catch bar extending along a length of the second surface of the clip body.

4. A clip as defined in claim 3, wherein the second surface of the sliding tension clasp comprises at least one button to work in conjunction with the catch bar, whereby the at least one button prevents the sliding tension clasp from detaching from the clip body.

5. A clip as defined in claim 1, wherein the material is clothing.

6. A clip as defined in claim 5, wherein the drying process comprises air drying or machine drying.

7. A clip as defined in claim 1, wherein the first surface of the clip body comprises an indent along a length of the first surface of the clip body, and the first surface of the sliding tension clasp comprises a rolled portion at a lower end of the first surface of the sliding tension clasp, the rolled portion mating with the indent along the length of the first surface of the clip body when the clip is in the closed position.

8. A method utilizing a clip in a drying process, the method comprising the steps of:
(a) wetting a material;
(b) attaching a clip to a portion of the material, the clip comprising first and second opposing surfaces, the attaching comprising the steps of:
opening the clip;
inserting the material between the first and second surfaces of the clip; and
closing the first and second surfaces of the clip, thereby resulting in the inserted material being substantially flattened; and
(c) drying the material while the clip is attached to the portion of the material.

9. A method as defined in claim 8, wherein the material is clothing.

10. A method as defined in claim 8, wherein step (c) comprises drying the material in a drying machine or air drying the material.

11. A method utilizing a clip in a drying process, the method comprising the steps of:
(a) wetting an article of clothing;
(b) attaching the clip to a portion of the clothing, the clip comprising:
a clip body having a first and second opposing surface, the first and second surfaces being joined to one another by a hinge mechanism located at an upper end of the first and second surfaces; and
a sliding tension clasp positioned atop the clip body, the sliding tension clasp comprising:
a first surface which mates with the first surface of the clip body; and
a second surface which mates with the second surface of the clip body, the second surface of the sliding tension clasp opposing the first surface of the sliding tension clasp, wherein the sliding tension clasp is adapted to move up and down the first and second opposing surfaces of the clip body;
wherein the clip is in an open position when the sliding tension clasp is moved up the clip body, and the clip is in a closed position when the sliding tension clasp is moved down the clip body, the material being held between the first and second opposing surfaces when the clip is in the closed position during the drying process;
(c) positioning the clip in the closed position; and
(d) drying the clothing while the clip is attached to the clothing.

12. A method as defined in claim 11, wherein step (d) comprises drying the clothing using the atmosphere or a dryer.

13. A method of making a clip that is applied to a material during a drying process, the method comprising the steps of:
(a) providing a clip body having a first and second opposing surface, the first and second surfaces being joined to one another by a hinge mechanism located at an upper end of the first and second surfaces; and
(b) providing a sliding tension clasp positioned atop the clip body, the sliding tension clasp comprising:
a first surface which mates with the first surface of the clip body; and
a second surface which mates with the second surface of the clip body, the second surface of the sliding tension clasp opposing the first surface of the sliding tension clasp, wherein the sliding tension clasp is adapted to move up and down the first and second opposing surfaces of the clip body;
wherein the clip is in an open position when the sliding tension clasp is moved up the clip body, and the clip is in a closed position when the sliding tension clasp is moved down the clip body, the material being held between the first and second opposing surfaces when the clip is in the closed position during the drying process.

14. A method as defined in claim 13, wherein the first surface of the clip body comprises an indented portion which mates with the first surface of the sliding tension clasp.

15. A method as defined in claim 13, wherein the second surface of the clip body comprises a catch bar extending along a length of the second surface of the clip body.

16. A method as defined in claim 15, wherein the second surface of the sliding tension clasp comprises at least one button to work in conjunction with the catch bar, whereby the at least one button prevents the sliding tension clasp from detaching from the clip body.

17. A method as defined in claim 13, wherein the first surface of the clip body comprises an indent along a length of the first surface of the clip body, and the first surface of the sliding tension clasp comprises a rolled portion at a lower end of the first surface of the sliding tension clasp, the rolled portion mating with the indent along the length of the first surface of the clip body when the clip is in the closed position.
